(19) United States
(12) Patent Application Publication
(10) Pub. No.: US 2015/0335513 A1
(43) Pub. Date: Nov. 26, 2015

(54) PORTABLE PERCUSSIVE TISSUE MASSAGER

(71) Applicant: JEFF LICHTHARDT, Barrington Hills, IL (US)

(72) Inventor: JEFF LICHTHARDT, Barrington Hills, IL (US)

(21) Appl. No.: 14/283,184

(22) Filed: May 20, 2014

(51) Int. Cl. A61H 1/00

(52) U.S. Cl. CPC A61H 1/008

(57) ABSTRACT

A tissue rehabilitation treatment apparatus including a base power unit, hand unit, drive cable, and massage head unit. An extended drive shaft communicates rotational energy from the power unit to the drive cable, which in turn causes rotational and linear vibrating movement in the massage head unit. The cable is immersed in lubricant within a protective'sheath to provide strain relief along the drive cable. The apparatus includes a means for adjusting the vibrating frequency for treating a variety of ailments.

### CROSS-REFERENCES TO RELATED APPLICATIONS

(Not Applicable)

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field Of The Invention

The embodiments of the present invention generally relate to professional-grade tissue massaging devices, and specifically to a portable apparatus for rehabilitating and treating tissue using vibrating technology to create a percussive body tissue treatment.

2. Description Of The Related Art

Tissue and muscle massagers are used in professional sports medicine to treat athletes. A massaging apparatus must be portable for use where needed; the treatment can occur alongside the playing field, or it can occur in a clinical setting. A deep tissue massage improves blood flow to the tissue and results in measurably improved performance by an athlete or even a racing horse.

The prior art units are bulky and the handles lack precision design to accommodate a grasping hand. The prior art apparatus has, a short drive shaft partially housed within the power unit and extending from the power into communication with a drive shaft cable. The other end of the drive cable is also connected to a short drive shaft extending into a massage handle unit. The shaft extends through the handle portion of the head unit into communication with an eccentric cam housed in the head unit. Rotational and linear movement of the cam causes a head portion to vibrate.

The prior art unit drive shaft is short and a loud vibration sound results as a therapist applies the massaging unit to the patient's body, due to the pressure being translated along the drive cable, as side-load induced resistance. The abbreviated, short drive shaft in the prior art mode cannot bear the lateral pressure, begins to rattle loudly and then fails. The sound is far too loud for use in a quiet therapy setting.

What is needed is a percussive massager that utilizes an extended drive shaft to respond to the motorized power more efficiently and in a way that reduces strain along the drive cable. The noise needs reduced and the design needs to be sleeker in order to make a massage unit more portable and suitable for a clinical setting. There is also a need for a percussive massager with a more flexible drive cable that can rotate at the needed rate. Finally, there is a need for a portable percussive massager with a hand-held massaging head unit with a handle machined precisely enough and secured strongly enough to the handle portion, so that the massaging head does not loosen from the handle under high frequency use.

### BRIEF SUMMARY OF THE INVENTION

The invention is a percussive massager with a base power unit, an extended drive shaft, a hand unit with an extended drive shaft, and a lubricated, sheathed drive cable extending between the handle unit shaft and power unit drive shaft. An eccentric cam drives the power unit shaft that in turn drives the sheathed and lubricated drive cable rotationally and linearly. The drive cable motion vibrates a massaging head at the other end of the cable. The power unit has a means for adjusting the vibrating frequency for treating various ailments and tissue types.

### BRIEF DESCRIPTION OF THE DRAWING

FIG. 1 is a view in perspective of the apparatus, showing sectional view of the protective sheath in order to reveal the drive cable.

FIG. 2 is a view in perspective of the underside of the massage unit head, showing the screws that help to hold the massage head to the handle.

In describing the preferred embodiment of the invention which is illustrated in the drawings, specific terminology will be resorted to for the sake of clarity.

### DETAILED DESCRIPTION OF THE INVENTION

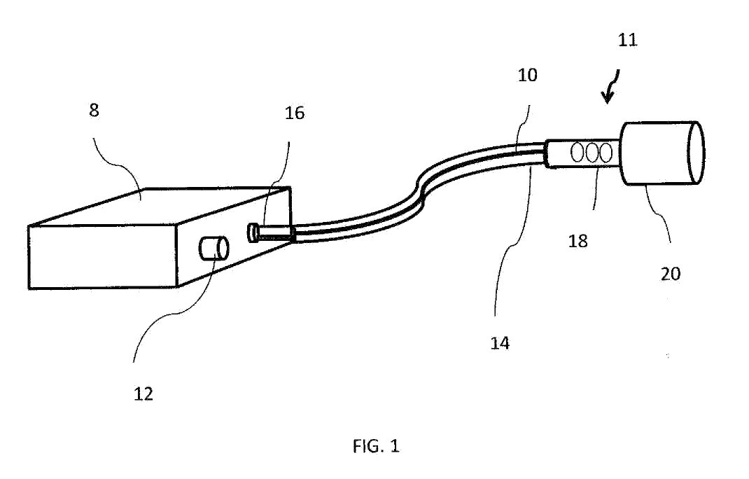

Looking at FIG. 1, the invention includes a power unit 8, a drive cable 10, and a massage head unit 11. An extended power shaft 16 is partially housed in the power unit 8. The power unit 8 has an eccentric cam that rotates and shifts the drive shaft 16 at a rate of up to three thousand two hundred rotations per minute (3200 RPM), resulting in a linear and rotational motion of the shaft 16.

The shaft 16 extends outwardly from the power unit 8 and is connected to an end of the drive cable 10. A transparent strain relief sheath 14 houses the drive cable 10. A lubricating mineral emersion lubricates the movement between of the cable 10 within the sheath. In the preferred embodiment, the emersion is a mineral oil and graphite mixture. The graphite absorbs friction heat energy from the rotation and compression movements of the drive cable 10 within the sheath 14. The oil relieves the tension in the interwoven mesh wires that comprise the drive cable 10.

Turning to the massage unit 11, an eccentric cam within the massage head 20 is linked, to a first end of an extended, longitudinal handle drive shaft. The extended handle drive shaft within the massage unit 11 is housed within the handle 18 and extends into the massage head 20.

A second end of the longitudinally extending handle shaft is linked to an end of the drive cable 10. As the drive cable 10 rotates and compresses, the eccentric cam drives the handle shaft into motion within the massage head 20. The motion is rotational and linear and results in a high frequency a vibration of the head 20.

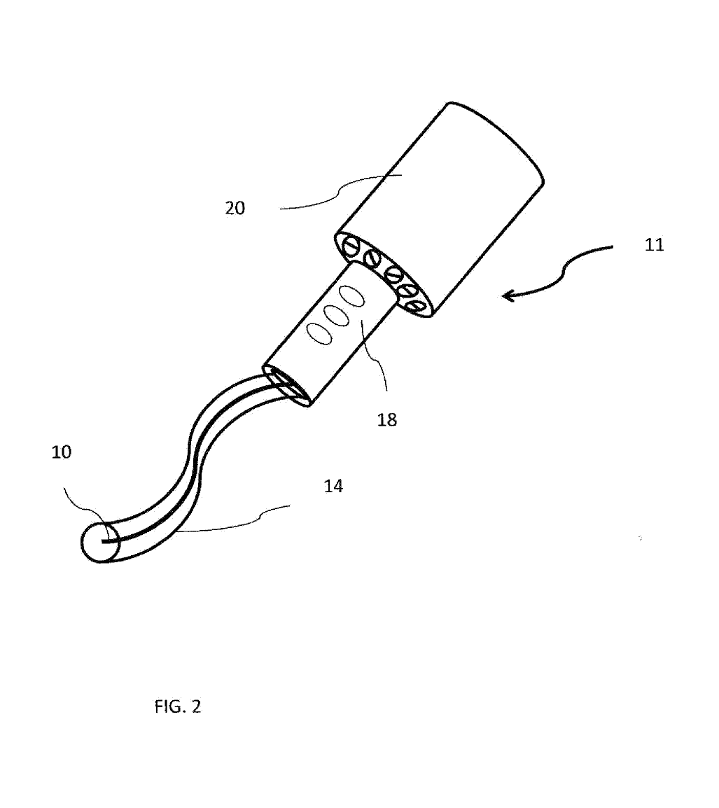

The handle 18 is formed with portions for a user to grasp. The handle 18 also has a substantially planar collar portion formed around the end of the handle 18 nearest the head 20. This collar is machined as part of the handle 18 and has a multiplicity of portions defining holes for the connecting devices. In the preferred embodiment, the holes are beveled to accept screw heads, and the head 20 has corresponding spaces threaded for accepting screws. The head 20 and handle 18 can also be fabricated as a singular unit in some instances. The preferred embodiment shown in FIG. 2 has multiple screws in order to maximize stability in the massage unit 11, by ensuring that the massage head 20 and handle 18 do not separate after prolonged use. The high frequency vibration does not separate the handle 18 and the head 20 after frequent use due to the high number of connecting devices and machine fitting.

During operation of the apparatus, the hand unit 11 is grasped at pre-formed portions on the handle 18 as the drive cable 10 rotates. The drive cable 10 serves to translate rotational energy into linear motion in the head 20 of the hand unit 11. The head 20 of the hand unit 11 is applied to the affected tissue area.

A user rotates a variable resistor knob 12 in order to alter the frequency of the rotation and linear movement of the extended drive shaft 16 to a desired rate for the particular ailment. This process is repeated to generate the desired treatment effect.

The apparatus may be fabricated using known manufacturing and machining techniques and of materials such as plastics, composites, alloys, metals, etc. Constructing the apparatus may be fabricated using various connecting devices such as screws, rivets, welds and similar devices. The apparatus is portable so that practitioners may transport it to patients.

While certain preferred embodiments of the present invention have been disclosed in detail. it is to be understood that various modifications may be adopted without departing from the spirit of the invention or scope of the following claims.

We claim:

1. An apparatus comprising:
a base power unit having an extended rotational power drive shaft extending from a housing a motor controlled by a variable frequency drive;
a massage unit having portions defining a handle grip and a cylindrical head housing, said head housing containing a mechanism for converting rotational energy into linear energy;
a drive member comprising a drive cable contained within a lubricating protective sheath, said drive cable having a first end configured to connect with said power drive shaft of said power unit and a second end configured to connect to a longitudinal extended handle shaft contained within said handle grip,
wherein said motor is configured to rotationally drive said power drive shaft, which causes said mechanism to convert said rotational energy into linear energy along said drive cable contained within said lubricating sheath such that said rotational energy and said linear energy are translated along said longitudinal handle shaft within said handle and to said head.

2. The apparatus of claim 1, wherein said lubricating material is a mineral oil and graphite immersion.

3. The apparatus of claim 1, wherein said two ends of said drive cable have a square cross section.

4. An apparatus comprising:
a base power unit having an extended rotational power drive shaft extending from a housing a motor controlled by a variable frequency drive;
a massage unit having portions defining a handle grip and a cylindrical head housing. said head housing containing a mechanism for converting rotational energy into linear energy, and said handle grip having portions defining a cylindrical collar with a multiplicity of void spaces for accepting a series of connecting devices, an said head housing having a corresponding series of portions for accepting said connecting devices, for securing said handle and head housing together;
a drive member comprising a drive cable contained within a lubricating protective sheath, said drive cable having a first end configured to connect with said power drive shaft of said power unit and a second end configured to connect to a longitudinal extended handle shaft contained within said handle grip,
wherein said motor is configured to rotationally drive said power drive shaft up to a maximum rate of 3200 rotations per minute, which causes said mechanism to convert said rotational energy into linear energy along said drive cable contained within said lubricating sheath such that said rotational energy and said linear energy are translated along said longitudinal handle shaft within said handle and to said head.
